(19) United States
(12) Patent Application Publication
(10) Pub. No.: US 2008/0186688 A1
(43) Pub. Date: Aug. 7, 2008

(54) Method of Mounting a Circuit Board

(76) Inventors: Avihu Nachmani, Vancouver (CA); Victor Elias, Vancouver (CA)

Correspondence Address: ANTOINETTE M. TEASE, P. O. BOX 51016, BILLINGS, MT, 59105, US

(21) Appl. No.: 11/817,255

(22) PCT Filed: Mar. 1, 2006
(86) PCT No.: PCT/CA2006/000288

§ 371 Date: Aug. 28, 2007

Related U.S. Application Data
(60) Provisional application No. 60/658,040, filed on Mar. 1, 2005.

(51) Int. Cl. H01R 43/00

(52) U.S. Cl. 361/752; 29/729; 29/428

(57) ABSTRACT

A circuit board is mountable inside a case that houses a user interface device, such that the circuit board is proximate to a portion of an external wall of the case. The portion is situated such that when the case is oriented for the user interface device to be in communication with a user, the portion is conveniently between the circuit board and a location outside and relative to the case that is occupyable by an external device operable to communicate with the circuit board.

### BACKGROUND OF THE INVENTION

1. Field of the Invention

The present invention relates to a method of mounting a radio frequency identification (“RFID”) module, for example an RFID coupler or controller combined with an antenna on one or more circuit boards. The method is particularly useful for mounting an RFID module in a general-purpose handheld computer, especially a ruggedized computer, but is not limited to such applications. While the method is particularly useful for mounting RFID modules, it is not limited to such applications and might beneficially be used to mount other types of circuit boards, particularly circuit boards for processing radio frequency signals.

2. Description of Challenges in the Art

Mounting a circuit board within a device presents a number of well-known challenges. Desirably, the mounting arrangement will successfully balance a number of requirements. The circuit board and its connection to the device should be able to survive expected hazards, such as impact to the device, particularly in the case of ruggedized devices. The circuit board should be easy to mount and dismount, particularly in the case of circuit boards that will be installed by end-users. The circuit board should be mounted so as to occupy space efficiently, so as not to block airflow or access to other components or connectors.

All of these challenges are presented by the task of mounting an RFID module, for example within a ruggedized general-purpose handheld computer, to enable the computer to read data from and write data to RFID devices. However, mounting RFID modules presents additional challenges as well. With RFID modules, electromagnetic coupling is a particular concern. It is desirable to mount an RFID module such that:
the RFID module is not a source of significant electromagnetic interference for other components;
other components are not a source of significant electromagnetic interference for the RFID module; and
there can be a good electromagnetic signal path between the RFID module and external RFID devices it might communicate with.

In the case of RFID modules that communicate with passive RFID tags using a high frequency carrier signal, it is particularly helpful if the RFID module can be positioned close to the RFID tag in order to shorten the electromagnetic signal path and thus significantly reduce the necessary transmission power.

### SUMMARY OF THE INVENTION

The present invention is directed to these challenges.

According to one aspect of the present invention, there is provided a method of mounting a circuit board inside a case adapted to house a user interface device, comprising mounting the circuit board proximate to a portion of an external wall of the case, the portion being situated such that when the case is oriented for the user interface device to be in communication with a user, the portion is conveniently between the circuit board and a location outside and relative to the case that is occupyable by an external device operable to communicate with the circuit board.

The portion might be the closest wall of the case to the location and might be, for example, on the bottom of the case. The portion might be remote from other components within the case. The circuit board might be mounted on an inside surface of the portion and might even by mounted directly to that inside surface. The portion might include an access panel.

Should the circuit board be disposed for radio communication with an external device in the location, the shortest or otherwise best communication path between the circuit board and the location might pass through the portion. In one arrangement, the circuit board might be a radio frequency identification module and the external device a radio frequency identification tag. In this vein, the radio frequency identification tag might be passive and the radio frequency identification module might communicate with the radio frequency identification tag using a high frequency carrier signal.

The method might further include at least one of: (a) framing the circuit board with reinforcing ribs on the inside surface of the access panel; (b) sandwiching a resilient gasket between the access panel and the case; (c) mating at least one of the reinforcing ribs with the gasket; and (d) connecting the access panel to the case with a set of fasteners and complemental couplings that are distributed about the perimeter of the access panel.

According to another aspect of the present invention, there is provided a method of mounting a circuit board inside a case, comprising mounting the circuit board on an access panel, for example mounting the circuit board directly to an inside surface of the access panel.

The method might further include: framing the circuit board with reinforcing ribs on the inside surface of the access panel; sandwiching a resilient gasket between the access panel and the case; connecting the access panel to the case with a set of fasteners and complemental couplings that are distributed about the perimeter of the access panel; or mating at least one of the reinforcing ribs with the gasket.

According to yet another aspect of the present invention, there is provided a method of mounting a circuit board inside a general-purpose handheld computer having a user interface device and a case with an access panel, comprising: (a) mounting the circuit board on the inside surface of the access panel; (b) framing the circuit board with reinforcing ribs on the inside surface of the access panel; (c) sandwiching a resilient gasket between the access panel and the case; and (d) connecting the access panel to the case with a set of fasteners and complemental couplings that are distributed about the perimeter of the access panel. The method might further include mating at least one of the reinforcing ribs with the gasket.

In one arrangement, the access panel is situated such that when the case is oriented for the user interface device to be in communication with a user, the access panel is conveniently between the circuit board and a location outside and relative to the case that is occupyable by an external device operable to communicate with the circuit board. The access panel might be the closest part of the case to the location and might be, for example, on the bottom of the case. Additionally, the access panel might be remote from other components within the case.

Where the circuit board is disposed for radio communication with an external device in the location, the shortest or otherwise best communication path between the circuit board and the location might pass through the access panel. For example, the circuit board might be a radio frequency identification module and the external device a radio frequency identification tag. In this vein, the radio frequency identification tag might be passive and the radio frequency identification module might communicate with the radio frequency identification tag using a high frequency carrier signal.

According to still another aspect of the present invention, there is provided an apparatus for mounting a circuit board inside a case adapted to house a user interface device, comprising means for mounting the circuit board proximate to a portion of an external wall of the case, the portion being situated such that when the case is oriented for the user interface device to be in communication with a user, the portion is conveniently between the circuit board and a location outside and relative to the case that is occupyable by an external device operable to communicate with the circuit board.

In this regard, the portion might be the closest wall of the case to the location and might in fact be on the bottom of the case. Additionally, the portion might be remote from other components within the case.

Where the circuit board is disposed for radio communication with an external device in the location, the shortest or otherwise best communication path between the circuit board and the location might pass through the portion. For example, the circuit board might be a radio frequency identification module and the external device a radio frequency identification tag. In this vein, the radio frequency identification tag might be passive and the radio frequency identification module might communicate with the radio frequency identification tag using a high frequency carrier signal.

The mounting means might include means for mounting the circuit board on an inside surface of the portion, possibly directly to the inside surface of the portion, or perhaps an access panel.

The apparatus might further include at least one of: (a) means for framing the circuit board with reinforcing ribs on the inside surface of the access panel; (b) means for sandwiching a resilient gasket between the access panel and the case; (c) means for mating at least one of the reinforcing ribs with the gasket; and (d) means for connecting the access panel to the case with a set of fasteners and complemental couplings that are distributed about the perimeter of the access panel.

According to another aspect of the present invention, there is provided an apparatus for mounting a circuit board inside a case, comprising means for mounting the circuit board on an access panel, perhaps directly to an inside surface of the access panel.

The apparatus might further include: means for framing the circuit board with reinforcing ribs on the inside surface of the access panel; means for sandwiching a resilient gasket between the access panel and the case; means for connecting the access panel to the case with a set of fasteners and complemental couplings that are distributed about the perimeter of the access panel; or means for mating at least one of the reinforcing ribs with the gasket.

According to another aspect of the present invention, there is provided an apparatus for mounting a circuit board inside a general-purpose handheld computer having a user interface device and a case with an access panel, comprising: (a) means for mounting the circuit board on the inside surface of the access panel; (b) means for framing the circuit board with reinforcing ribs on the inside surface of the access panel; (c) means for sandwiching a resilient gasket between the access panel and the case; and (d) means for connecting the access panel to the case with a set of fasteners and complemental couplings that are distributed about the perimeter of the access panel. The apparatus might also include means for mating at least one of the reinforcing ribs with the gasket.

The apparatus might be characterized by the access panel being situated such that when the case is oriented for the user interface device to be in communication with a user, the access panel is conveniently between the circuit board and a location outside and relative to the case that is occupyable by an external device operable to communicate with the circuit board.

In some arrangements, the access panel might be the closest part of the case to the location or might be on the bottom of the case. The access panel might be remote from other components within the case.

Where the circuit board is disposed for radio communication with an external device in the location, the shortest or otherwise best communication path between the circuit board and the location might pass through the access panel. In some arrangements, the circuit board might be a radio frequency identification module and the external device a radio frequency identification tag. In this vein, the radio frequency identification tag might be passive and the radio frequency identification module might communicate with the radio frequency identification tag using a high frequency carrier signal.

According to another aspect of the present invention, there is provided a case adapted to house a user interface device and to retain a circuit board proximate to a portion of its external wall, characterized by the portion being situated such that when the case is oriented for the user interface device to be in communication with a user, the portion is conveniently between the circuit board and a location outside and relative to the case that is occupyable by an external device operable to communicate with the circuit board. The portion might be the closest wall of the case to the location; it might be on the bottom of the case. As well, the portion is remote from other components within the case.

Where the circuit board is retained in disposition for radio communication with an external device in the location, the shortest or otherwise best communication path between the circuit board and the location might pass through the portion. The circuit board might be, for example, a radio frequency identification module and the external device a radio frequency identification tag. In this vein, the radio frequency identification tag might be passive and the radio frequency identification module might communicate with the radio frequency identification tag using a high frequency carrier signal.

The portion might be adapted to retain the circuit board proximate an inside surface or to retain the circuit board directly on the inside surface, in either case perhaps an access panel removable from the main body of the case.

The case might further include: (a) reinforcing ribs on the inside surface of the access panel adapted to frame the circuit board; (b) a resilient gasket insertable between the access panel and the main body of the case; or (c) a set of fasteners and complemental couplings distributed about the perimeter of the access panel adapted to connect the access panel to the main body of the case. Additionally, at least one of the reinforcing ribs might be adapted to mate with the resilient gasket.

According to still another aspect of the present invention, there is provided an apparatus for mounting a circuit board inside a case having an access in its external wall, comprising an access panel complemental with the access and adapted to retain the circuit board. The access panel might be adapted to retain the circuit board directly on an inside surface or might include reinforcing ribs on its inside surface for framing the circuit board.

The apparatus might further include a resilient gasket insertable between the access panel and the case, in which case at least one of the reinforcing ribs might mate with the gasket.

The apparatus might further include a set of fasteners and complemental couplings distributed about the perimeter of the access panel and the access for connecting the access panel to the case.

According to still another aspect of the present invention, there is provided a general-purpose handheld computer having a user interface device and a case with an access panel, comprising: (a) reinforcing ribs on the inside surface of the access panel for framing a circuit board; (b) a resilient gasket insertable between the access panel and the case; and (d) a set of fasteners and complemental couplings that are distributed about the perimeter of the access panel for connecting the access panel to the case and sandwiching the gasket. At least one of the reinforcing ribs might be adapted to mate with the gasket.

The apparatus might further include a circuit board adapted to be framed within the reinforcing ribs on the inside surface of the access panel.

The apparatus might be characterized by the access panel being situated such that when the case is oriented for the user interface device to be in communication with a user, the access panel is conveniently between the circuit board and a location outside and relative to the case that is occupyable by an external device operable to communicate with the circuit board.

The access panel might be the closest part of the case to the location, for example the access panel might be on the bottom of the case. Perhaps the access panel is remote from other components within the case.

Where the circuit board is disposed for radio communication with an external device in the location, the shortest or otherwise best communication path between the circuit board and the location might pass through the access panel. For example, the circuit board might be a radio frequency identification module and the external device a radio frequency identification tag. In this vein, the radio frequency identification tag might be passive and the radio frequency identification module might communicate with the radio frequency identification tag using a high frequency carrier signal.

### DESCRIPTION OF THE INVENTION

The invention will be more fully illustrated by the following detailed description of non-limiting specific embodiments in conjunction with the accompanying drawing figures. In the figures, similar components and/or features may have the same reference label.

### BRIEF DESCRIPTION OF THE DRAWINGS

FIG. 1 is a perspective top-left-front view of a ruggedized general-purpose handheld computer;

FIG. 2 is a perspective bottom-left-back view of the computer of FIG. 1, showing an access panel in the bottom surface of the computer;

FIG. 3 is an exploded perspective top-left-front view of the computer of FIG. 1, with the access panel removed;

FIG. 4 is an exploded perspective bottom-left-back view of the computer of FIG. 1, with the access panel removed;

FIG. 5 is a perspective top-left-front view of the computer of FIG. 1, showing the access panel removed from the computer;

FIG. 6 is a perspective bottom-left-back view of the computer of FIG. 1, showing the access panel removed from the computer;

FIG. 7 is a plan sectional view of the computer of FIG. 1, viewed from the cutting plane A-A;

FIG. 8 is a plan sectional view of the computer of FIG. 1, viewed from the cutting plane B-B;

FIG. 9 is a lateral sectional view of the computer of FIG. 1, viewed from the cutting plane C-C; and

FIG. 10 is an exploded lateral sectional view of the computer of FIG. 1, viewed from the cutting plane D-D.

### DETAILED DESCRIPTION OF SPECIFIC EMBODIMENTS

The invention will now be illustrated by way of explanation of non-limiting specific exemplary embodiments shown in the drawing figures and described in greater detail herein.

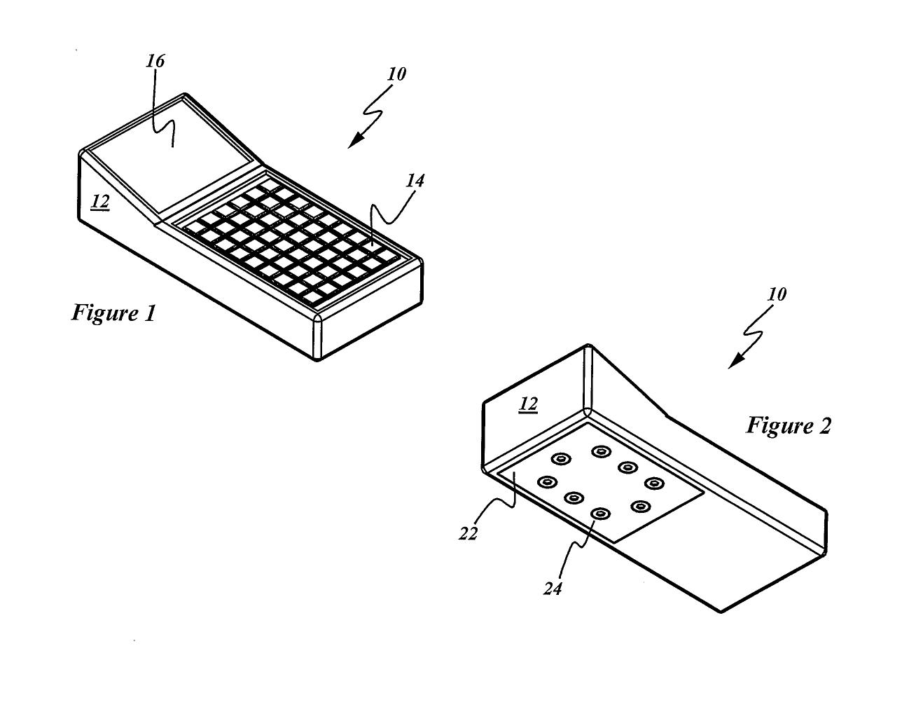

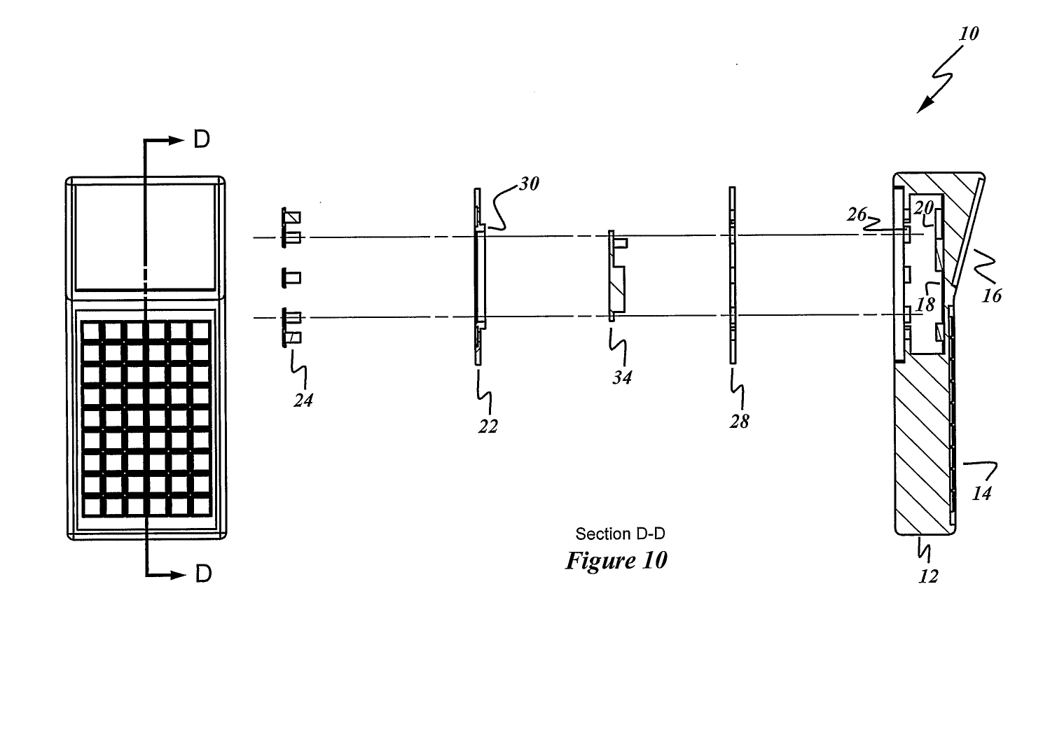

FIG. 1 shows a ruggedized general-purpose handheld computer, generally illustrated at 10. The computer 10 includes a ruggedized case 12 which protects an input device (here a keypad 14), an output device (here a liquid crystal display or LCD 16), and a main circuit board 18 (best seen in FIGS. 4, 6, 8, 9 and 10) that provides the functionality of a general-purpose computer, including storage and processing of data and instructions and communication of data and instructions with peripheral devices, including the keypad 14 and the LCD 16. To better enable communication with peripheral devices, the main circuit board 18 also includes a bus connector 20, best seen in FIGS. 8, 9 and 10, to enable connection of a peripheral device to an address bus and/or a data bus (not shown) on the main circuit board 18.

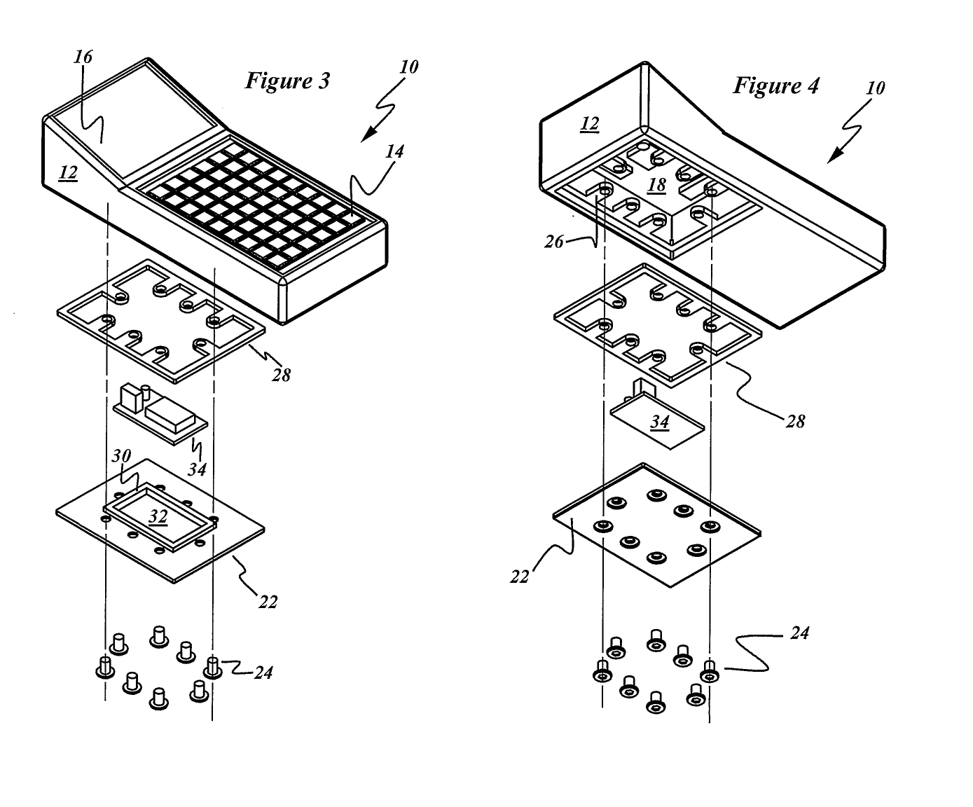

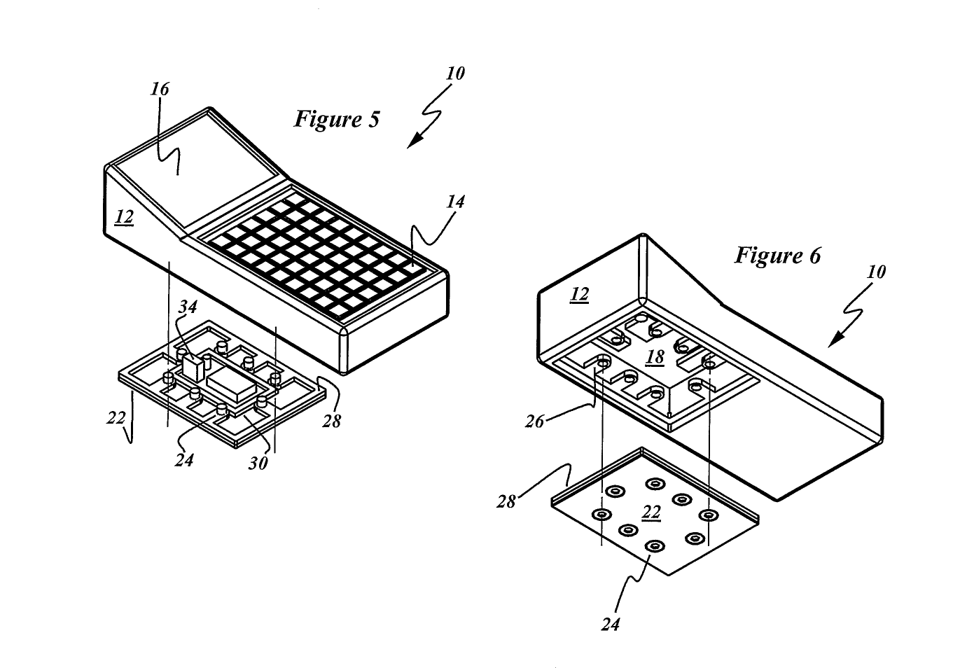

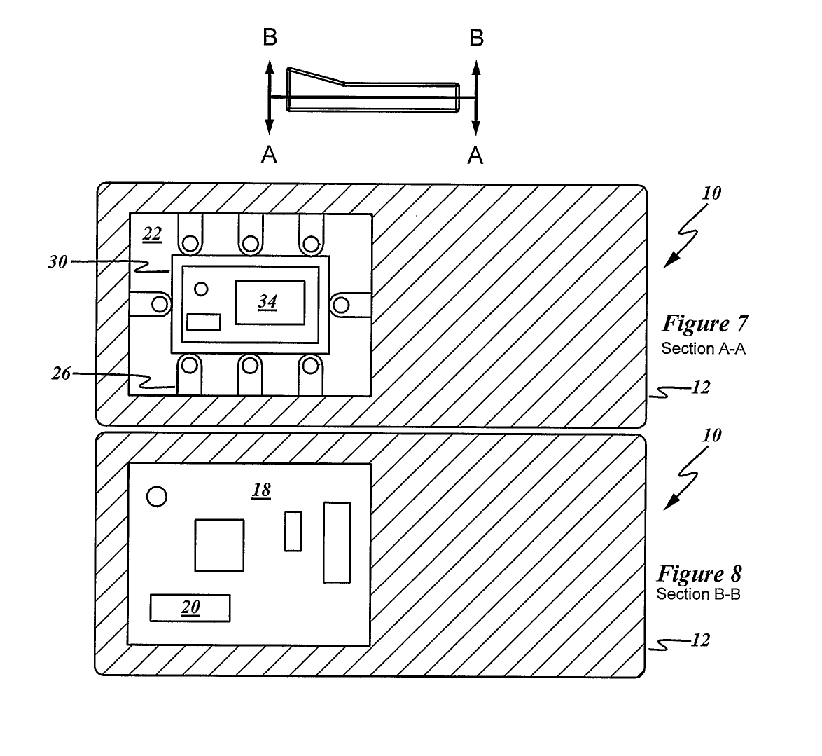

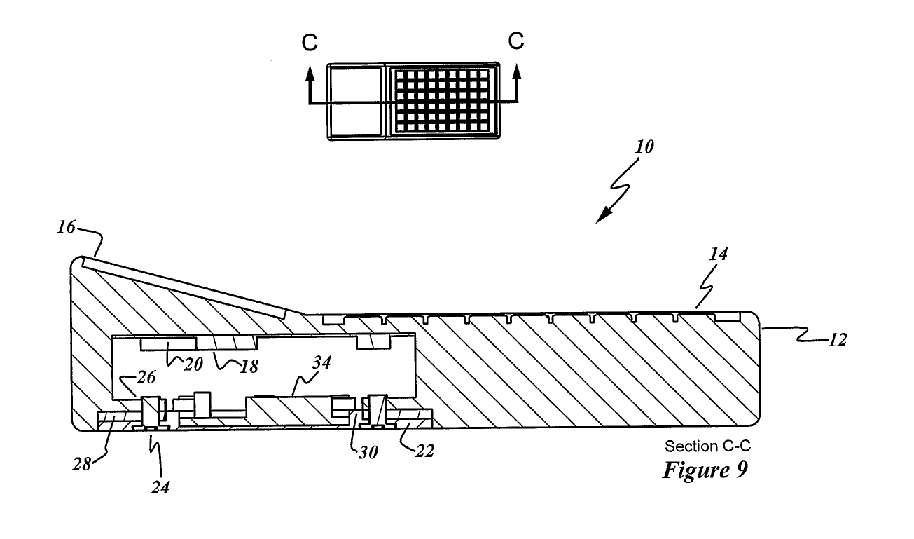

The case 12 further includes an access panel 22 on its bottom surface. The panel 22 is secured to the case 12 by a set of fasteners 24, for example threaded fasteners, generally distributed about its perimeter. As best seen in FIGS. 4 and 9, the fasteners 24 engage the case 12 through a set of complemental couplings 26, for example nuts, attached to or integrated with the case 12. As best seen in FIGS. 3, 4, 5, 6, 9 and 10, the case 12 and the panel 22 sandwich between them a resilient dust gasket 28. As best seen in FIGS. 3, 5, 7 and 10, the panel 22 further includes a set of reinforcing ribs 30, that desirably mate with the gasket 28 and frame a mounting area 32, though neither the mating nor the framing need be continuous.

As best seen in FIGS. 3, 4, 5, 7, 9 and 10, the computer 10 might also include an RFID module 34 for providing the computer 10 with the ability to read data from and write data to RFID devices (not shown) and to process such data.

Although the RFID module 34 might be connected directly to the main circuit board 18 at the bus connector 20, that arrangement could present a number of problems. First, an end-user might damage the main circuit board 18 when trying to insert the RFID module 34 into the bus connector 20 or might at least avoid making the connection for fear of causing such damage. Second, the RFID module 34 might obstruct access to the main circuit board 18, such that it might be difficult to add other components, for example expansion cards for providing additional functionality or capacity. Third, when transmitting a radio frequency signal to an RFID device, the RFID module 34 is a source of electromagnetic radiation and should therefore be located remote from the main circuit board 18 to reduce interference. Fourth, when communicating with an RFID device, the RFID module 34 needs to be sufficiently close to the RFID device to establish a good radio frequency communication path and sufficiently remote from other components in the computer 10 to avoid interference from their electromagnetic radiation. For reliable communication, the RFID module 34 should be no more than a few inches from an RFID device and so the RFID module 34 should be located close to the wall of the case 12, most desirably the bottom of the case so that when the RFID module 34 is aimed at an RFID device, the keypad 14 and the LCD 16 face the end-user.

For the above reasons, it has been found that the inside surface of the access panel 22 is a suitable location to mount the RFID module 34. The RFID module 34 can be sized and shaped to fit within the mounting area 32 framed by the reinforcing ribs 30, the ribs helping to retain the RFID module 34 therewithin and providing protection against impact. The RFID module 34 is additionally protected by the resilient dust gasket 28, which provides shock absorption against impact to the panel 22 and by the set of fasteners 24 and complemental couplings 26, which are distributed about the perimeter of the panel 22 to better diffuse impact forces throughout to panel 22 and the case 12 as a whole.

With the RFID module 34 so mounted on the access panel 22, the bus connector 20 can include, either at manufacture or after-market, a flexible ribbon cable (not shown) or equivalent that an end-user can easily connect to the RFID module 34, without applying force to the main circuit board 18.

Thus, it will be seen from the foregoing embodiments and examples that there has been described an advantageous way to mount a circuit board, and in particular an RFID module 34, within a case 12, for example the case 12 of a general-purpose handheld computer 10. Advantages of the invention can be obtained by singly or in combination:
mounting a RFID module 34, directly or indirectly, to the inside surface of an access panel 22 in the case 12;
framing the RFID module 34 with reinforcing ribs 30 on the inside surface of the access panel 22;
sandwiching a resilient gasket 28 between the access panel 22 and the case 12;
connecting the access panel 22 to the case 12 with a set of fasteners 24 and complemental couplings 26 that are distributed about the perimeter of the panel 22;
mounting the RFID module 34 proximate to an external wall of the case 12 for shortening the radio frequency signal path to external devices;
mounting the RFID module 34 proximate to that external wall of the case 12, typically the bottom wall, that in typical operation would provide the shortest or otherwise best radio frequency signal path to external devices when the keypad 14 and LCD 16 face the end-user; and
mounting the RFID module 34 remote from other components, including the main circuit board 18, to avoid either being a significant source of electromagnetic interference to the other.

While specific embodiments of the invention have been described and illustrated, such embodiments should be considered illustrative of the invention only and not as limiting the invention. It will be understood by those skilled in the art that various changes, modifications and substitutions can be made to the foregoing embodiments without departing from the principle and scope of the invention expressed in the claims made herein. While the invention has been described as having particular application to ruggedized, general-purpose handheld computers and RFID modules, those skilled in the art will recognize that aspects of the invention have wider application, for example for mounting other types of modules and circuit boards and for mounting in other types of devices, such as personal digital assistants, telephones, test equipment, and larger computers, including workstations, desktop computers and laptop computers.

What is claimed is:

1. A method of mounting a circuit board inside a case adapted to house a user interface device, comprising mounting the circuit board proximate to a portion of an external wall of the case, the portion being situated such that when the case is oriented for the user interface device to be in communication with a user, the portion is conveniently between the circuit board and a location outside and relative to the case that is occupyable by an external device operable to communicate with the circuit board.

2. A method as claimed in claim 1, wherein the portion is the closest wall of the case to the location.

3. A method as claimed in claim 2, wherein the portion is on the bottom of the case.

4. A method as claimed in claim 3, wherein the circuit board is disposed for radio communication with an external device in the location.

5. A method as claimed in claim 4, wherein the shortest communication path between the circuit board and the location passes through the portion.

6. A method as claimed in claim 4, wherein the best communication path between the circuit board and the location passes through the portion.

7. A method as claimed in claim 4, wherein the circuit board is a radio frequency identification module and the external device is a radio frequency identification tag.

8. A method as claimed in claim 7, wherein the radio frequency identification tag is passive and the radio frequency identification module communicates with the radio frequency identification tag using a high frequency carrier signal.

9. A method as claimed in claim 1, wherein the portion is remote from other components within the case.

10. A method as claimed in claim 1, wherein mounting the circuit board includes mounting the circuit board on an inside surface of the portion.

11. A method as claimed in claim 10, wherein mounting the circuit board includes mounting the circuit board directly to the inside surface of the portion.

12. A method as claimed in claim 10, wherein mounting the circuit board on an inside surface of the portion includes mounting the circuit board on an access panel.

13. A method as claimed in claim 12, further comprising at least one of:
(a) framing the circuit board with reinforcing ribs on the inside surface of the access panel;
(b) sandwiching a resilient gasket between the access panel and the case;
(c) mating at least one of the reinforcing ribs with the gasket; and
(d) connecting the access panel to the case with a set of fasteners and complemental couplings that are distributed about the perimeter of the access panel.

14. A method of mounting a circuit board inside a case, comprising mounting the circuit board on an access panel.

15. A method as claimed in claim 14, wherein mounting includes mounting the circuit board directly to an inside surface of the access panel.

16. A method as claimed in claim 15, further comprising framing the circuit board with reinforcing ribs on the inside surface of the access panel.

17. A method as claimed in claim 16, further comprising sandwiching a resilient gasket between the access panel and the case.

18. A method as claimed in claim 17, further comprising connecting the access panel to the case with a set of fasteners and complemental couplings that are distributed about the perimeter of the access panel.

19. A method as claimed in claim 18, further comprising mating at least one of the reinforcing ribs with the gasket.

20. A method of mounting a circuit board inside a general-purpose handheld computer having a user interface device and a case with an access panel, comprising:
(a) mounting the circuit board on the inside surface of the access panel;
(b) framing the circuit board with reinforcing ribs on the inside surface of the access panel;
(c) sandwiching a resilient gasket between the access panel and the case; and
(d) connecting the access panel to the case with a set of fasteners and complemental couplings that are distributed about the perimeter of the access panel.

21. A method as claimed in claim 20, further comprising mating at least one of the reinforcing ribs with the gasket.

22. A method as claimed in claim 20, wherein the access panel is situated such that when the case is oriented for the user interface device to be in communication with a user, the access panel is conveniently between the circuit board and a location outside and relative to the case that is occupyable by an external device operable to communicate with the circuit board.

23. A method as claimed in claim 22, wherein the access panel is the closest part of the case to the location.

24. A method as claimed in claim 23, wherein the access panel is on the bottom of the case.

25. A method as claimed in claim 24, wherein the circuit board is disposed for radio communication with an external device in the location.

26. A method as claimed in claim 25, wherein the shortest communication path between the circuit board and the location passes through the access panel.

27. A method as claimed in claim 25, wherein the best communication path between the circuit board and the location passes through the access panel.

28. A method as claimed in claim 25, wherein the circuit board is a radio frequency identification module and the external device is a radio frequency identification tag.

29. A method as claimed in claim 28, wherein the radio frequency identification s tag is passive and the radio frequency identification module communicates with the radio frequency identification tag using a high frequency carrier signal.

30. A method as claimed in claim 23, wherein the access panel is remote from other components within the case.

31. An apparatus for mounting a circuit board inside a case adapted to house a user interface device, comprising means for mounting the circuit board proximate to a portion of an external wall of the case, the portion being situated such that when the case is oriented for the user interface device to be in communication with a user, the portion is conveniently between the circuit board and a location outside and relative to the case that is occupyable by an external device operable to communicate with the circuit board.

32. An apparatus as claimed in claim 31, wherein the portion is the closest wall of the case to the location.

33. An apparatus as claimed in claim 32, wherein the portion is on the bottom of the case.

34. An apparatus as claimed in claim 33, wherein the circuit board is disposed for radio communication with an external device in the location.

35. An apparatus as claimed in claim 34, wherein the shortest communication path between the circuit board and the location passes through the portion.

36. An apparatus as claimed in claim 34, wherein the best communication path between the circuit board and the location passes through the portion.

37. An apparatus as claimed in claim 34, wherein the circuit board is a radio frequency identification module and the external device is a radio frequency identification tag.

38. An apparatus as claimed in claim 37, wherein the radio frequency identification tag is passive and the radio frequency identification module communicates with the radio frequency identification tag using a high frequency carrier signal.

39. An apparatus as claimed in claim 31, wherein the portion is remote from other components within the case.

40. An apparatus as claimed in claim 31, wherein the mounting means includes means for mounting the circuit board on an inside surface of the portion.

41. An apparatus as claimed in claim 40, wherein the mounting means includes means for mounting the circuit board directly to the inside surface of the portion.

42. An apparatus as claimed in claim 40, wherein the mounting means includes means for mounting the circuit board on an access panel.

43. An apparatus as claimed in claim 42, further comprising at least one of:
(a) means for framing the circuit board with reinforcing ribs on the inside surface of the access panel;
(b) means for sandwiching a resilient gasket between the access panel and the case;
(c) means for mating at least one of the reinforcing ribs with the gasket; and
(d) means for connecting the access panel to the case with a set of fasteners and complemental couplings that are distributed about the perimeter of the access panel.

44. An apparatus for mounting a circuit board inside a case, comprising means for mounting the circuit board on an access panel.

45. An apparatus as claimed in claim 44, wherein the mounting means includes means for mounting the circuit board directly to an inside surface of the access panel.

46. An apparatus as claimed in claim 45, further comprising means for framing the circuit board with reinforcing ribs on the inside surface of the access panel.

47. An apparatus as claimed in claim 46, further comprising means for sandwiching a resilient gasket between the access panel and the case.

48. An apparatus as claimed in claim 47, further comprising means for connecting the access panel to the case with a set of fasteners and complemental couplings that are distributed about the perimeter of the access panel.

49. An apparatus as claimed in claim 48, further comprising means for mating at least one of the reinforcing ribs with the gasket.

50. An apparatus for mounting a circuit board inside a general-purpose handheld computer having a user interface device and a case with an access panel, comprising:
(a) means for mounting the circuit board on the inside surface of the access panel;
(b) means for framing the circuit board with reinforcing ribs on the inside surface of the access panel;
(c) means for sandwiching a resilient gasket between the access panel and the case; and
(d) means for connecting the access panel to the case with a set of fasteners and complemental couplings that are distributed about the perimeter of the access panel.

51. An apparatus as claimed in claim 50, further comprising means for mating at least one of the reinforcing ribs with the gasket.

52. An apparatus as claimed in claim 50, wherein the access panel is situated such that when the case is oriented for the user interface device to be in communication with a user, the access panel is conveniently between the circuit board and a location outside and relative to the case that is occupyable by an external device operable to communicate with the circuit board.

53. An apparatus as claimed in claim 52, wherein the access panel is the closest part of the case to the location.

54. An apparatus as claimed in claim 53, wherein the access panel is on the bottom of the case.

55. An apparatus as claimed in claim 54, wherein the circuit board is disposed for radio communication with an external device in the location.

56. An apparatus as claimed in claim 55, wherein the shortest communication path between the circuit board and the location passes through the access panel.

57. An apparatus as claimed in claim 55, wherein the best communication path between the circuit board and the location passes through the access panel.

58. An apparatus as claimed in claim 55, wherein the circuit board is a radio frequency identification module and the external device is a radio frequency identification tag.

59. An apparatus as claimed in claim 58, wherein the radio frequency identification tag is passive and the radio frequency identification module communicates with the radio frequency identification tag using a high frequency carrier signal.

60. An apparatus as claimed in claim 53, wherein the access panel is remote from other components within the case.

61. A case adapted to house a user interface device and to retain a circuit board proximate to a portion of an external wall, characterized by the portion being situated such that when the case is oriented for the user interface device to be in communication with a user, the portion is conveniently between the circuit board and a location outside and relative to the case that is occupyable by an external device operable to communicate with the circuit board.

62. A case as claimed in claim 61, wherein the portion is the closest wall of the case to the location.

63. A case as claimed in claim 62, wherein the portion is on the bottom of the case.

64. A case as claimed in claim 63, wherein the circuit board is retained in disposition for radio communication with an external device in the location.

65. A case as claimed in claim 64, wherein the shortest communication path between the circuit board and the location passes through the portion.

66. A case as claimed in claim 64, wherein the best communication path between the circuit board and the location passes through the portion.

67. A case as claimed in claim 64, wherein the circuit board is a radio frequency identification module and the external device is a radio frequency identification tag.

68. An apparatus as claimed in claim 67, wherein the radio frequency identification tag is passive and the radio frequency identification module communicates with the radio frequency identification tag using a high frequency carrier signal.

69. A case as claimed in claim 61, wherein the portion is remote from other components within the case.

70. A case as claimed in claim 61, wherein the portion is adapted to retain the circuit board proximate an inside surface.

71. A case as claimed in claim 70, wherein the portion is adapted to retain the circuit board directly on the inside surface.

72. A case as claimed in claim 70, wherein the portion is adapted to retain the circuit board on an access panel removable from the main body of the case.

73. A case as claimed in claim 72, further comprising:
(a) reinforcing ribs on the inside surface of the access panel adapted to frame the circuit board;
(b) a resilient gasket insertable between the access panel and the main body of the case;
(c) a set of fasteners and complemental couplings distributed about the perimeter of the access panel adapted to connect the access panel to the main body of the case.

74. A case as claimed in claim 73, wherein at least one of the reinforcing ribs is adapted to mate with the resilient gasket.

75. An apparatus for mounting a circuit board inside a case having an access in its external wall, comprising an access panel complemental with the access and adapted to retain the circuit board.

76. An apparatus as claimed in claim 75, wherein the access panel is adapted to retain the circuit board directly on an inside surface.

77. An apparatus as claimed in claim 76, wherein the access panel further comprising reinforcing ribs on its inside surface for framing the circuit board.

78. An apparatus as claimed in claim 77, further comprising a resilient gasket insertable between the access panel and the case.

79. An apparatus as claimed in claim 78, wherein at least one of the reinforcing ribs mates with the gasket.

80. An apparatus as claimed in claim 78, further comprising a set of fasteners and complemental couplings distributed about the perimeter of the access panel and the access for connecting the access panel to the case.

81. A general-purpose handheld computer having a user interface device and a case with an access panel, comprising:
(a) reinforcing ribs on the inside surface of the access panel for framing a circuit board;
(b) a resilient gasket insertable between the access panel and the case; and
(d) a set of fasteners and complemental couplings that are distributed about the perimeter of the access panel for connecting the access panel to the case and sandwiching the gasket.

82. An apparatus as claimed in claim 81, wherein at least one of the reinforcing ribs is adapted to mate with the gasket.

83. An apparatus as claimed in claim 82, further comprising a circuit board adapted to be framed within the reinforcing ribs on the inside surface of the access panel.

84. An apparatus as claimed in claim 83, wherein the access panel is situated such that when the case is oriented for the user interface device to be in communication with a user, the access panel is conveniently between the circuit board and a location outside and relative to the case that is occupyable by an external device operable to communicate with the circuit board.

85. An apparatus as claimed in claim 84, wherein the access panel is the closest part of the case to the location.

86. An apparatus as claimed in claim 85, wherein the access panel is on the bottom of the case.

87. An apparatus as claimed in claim 86, wherein the circuit board is disposed for radio communication with an external device in the location.

88. An apparatus as claimed in claim 87, wherein the shortest communication path between the circuit board and the location passes through the access panel.

89. An apparatus as claimed in claim 87, wherein the best communication path between the circuit board and the location passes through the access panel.

90. An apparatus as claimed in claim 87, wherein the circuit board is a radio frequency identification module and the external device is a radio frequency identification tag.

91. An apparatus as claimed in claim 90, wherein the radio frequency identification tag is passive and the radio frequency identification module communicates with the radio frequency identification tag using a high frequency carrier signal.

92. An apparatus as claimed in claim 85, wherein the access panel is remote from other components within the case.
